(19) United States
(12) Patent Application Publication
(10) Pub. No.: US 2014/0223950 A1
(43) Pub. Date: Aug. 14, 2014

(54) TEMPERATURE CONTROL SYSTEM FOR VEHICLES

(71) Applicants: Bo Janeling, Kvicksund (SE); Michael Willix, Eskilstuna (SE); Pekka Ollila, Changwon-si Gyeongsangnam-do (KR)

(72) Inventors: Bo Janeling, Kvicksund (SE); Michael Willix, Eskilstuna (SE); Pekka Ollila, Changwon-si Gyeongsangnam-do (KR)

(73) Assignee: VOLVO CONSTRUCTION EQUIPMENT AB, Eskilstuna (SE)

(21) Appl. No.: 14/343,061

(22) PCT Filed: Sep. 9, 2011
(86) PCT No.: PCT/KR2011/006738

§ 371 Date: Mar. 6, 2014

(51) Int. Cl. B60H 1/32; B60H 1/04; B60H 1/00

(52) U.S. Cl. CPC B60H 1/323; B60H 1/00492; B60H 1/005; B60H 1/00885; B60H 1/04
USPC 62/333; 62/243; 62/438; 165/43

(57) ABSTRACT

A temperature control system for vehicles includes an evaporator constituting an air-conditioning system, a heater core, which is installed to be proximate to the evaporator, and heat-exchanges with the peripheral air while a coolant flows inside, a first coolant circulation line, which is connected to the heater core and allows the coolant heated by the engine to circulate between the heater core and the engine, a coolant storage, in which the coolant through the heater core is stored, and a second coolant circulation line, by which the heater core and the coolant storage are connected, and which allows the coolant to circulate between the heater core and the coolant storage, wherein the coolant cooled in the heater core by the heat-exchange between the evaporator and the heater core circulates along the second coolant circulation line to be stored in the coolant storage during the operation of the air-conditioning system, and the coolant stored in the coolant storage circulates along the second coolant circulation line to be supplied to the heater core during the stop of the air-conditioning system.

### BACKGROUND AND SUMMARY

The present invention relates to a temperature control system for vehicles. More particularly, the present invention relates to a temperature control system for vehicles, which can be used to supplement energy for cooling and heating by allowing the cooled or heated air to be supplied for a while after the engine stops. The temperature control system in the present invention is applicable not only to general vehicles, but also specifically to construction vehicles, such as an excavator, a loader, a dozer, etc.

When an air conditioning and heating system for cars operates, refrigerant leakage can cause global warming, which must be considered when designing an air conditioning and heating system.

The ratio of the warming of atmosphere caused by the use of a refrigerant is defined as Global Warming Potential (GWP). R134a, which is most commonly used as a refrigerant for air-conditioning (AC) systems, has a GWP higher than 1300.

In 2006, the European Union stipulated that as of 2011, refrigerants in newly developed vehicles cannot have a GWP greater than 150; and as of 2017, this will apply to all newly registered cars. As an alternative refrigerant, R1234yf has been developed. R1234yf has a very low GWP (4), although the initial cost of the product is much higher than that of R134a. The product could be handled in repair shops in the same way as R-134a, although it would require different, specialized equipment to perform the service. One of the reasons for that is the mild flammability of HFO-1234yf. No refrigerant couplings is allowed inside the cab. (see ISO13043) Since it still have a small affects the global warming, and safety handling it is still required to restrict the use of the new refrigerant, R1234yf.

To this end, it is required to design a cooling and heating system for vehicles to use a refrigerant in a relatively small amount and not to leak a refrigerant. As a way of reducing the required amount of a refrigerant, it can be considered to reduce the volume of an air-conditioning system. As a way of preventing a refrigerant from leaking, it can be considered to minimize the connection between the components constituting the air-conditioning system.

An air-conditioning system normally comprises a compressor, a condenser, a receiver-dryer, a expansion device (see ISO13043), and an evaporator. In order to modify the design of the air-conditioning system, various tests would be required in many different conditions. Thus, it would require lots of efforts to modify the design of the system.

Specifically, the operation of a compressor is affected very sensitively by the state of the oil used for the lubrication of the compressor, and thus a design modification of the air-conditioning system would be very difficult, as explained below.

A compressor is coated with oil for lubrication when a piston operates to compress a refrigerant. When the air conditioner operates, the oil is discharged together with a refrigerant and circulates in the air-conditioning system. Since the oil has the viscosity and specific gravity greater than those of the refrigerant, it does not lead to a phase change when the heat-exchange in the condenser and the evaporator leads to a phase change of a refrigerant. Thus, the efficiency and capability of a heat-exchanger are lowered due to delayed heat absorption and release rates. Further, if the oil, which circulates in the air-conditioning system, is returned to the compressor in a too small amount, the compressor will likely be damaged due to the poor lubrication. If extra oil is added to the system it may lead to poor cooling performance of the system.

If extra paths are formed by modification of the air-conditioning system, the oil, which circulates in the air-conditioning system, will be flowed into the extra paths, and thus the amount of oil to be returned to the compressor may be further reduced. In this case, the problem caused by the oil will likely be more serious, and it will be difficult to solve such problem.

Accordingly, it would be advantageous for the newly designed temperature control system to maintain the structure of the existing system as possible. That is, it would be required to minimize the change of the structure.

In order to improve fuel efficiency or as a countermeasure against the environmental pollution according to the exhaust control, a hybrid vehicle or an idle-stop vehicle has recently been developed.

The hybrid vehicle or idle-stop vehicle is configured to allow the engine to automatically stop when the vehicle stops to wait for the traffic light. Ifa normal air-conditioning system is adopted in such a vehicle, the operation of the compressor of the air-conditioning system, which is connected to the engine, will also stop and the supply of a heat source for cooling will be suspended or shortened, thereby lowering amenity inside the vehicle.

In order to solve this problem, researches for operating the air conditioner during stoppage time by providing the inside of the air-conditioning system with a storage function or a separate battery have been progressed.

Japanese Unexamined Patent Publication No. 2000-318431 relates to an air-conditioning system for vehicles, and discloses an air-conditioning system having a storage function therein.

FIG. 1 shows an air-conditioning system for vehicles according to Japanese Unexamined Patent Publication No. 2000-318431.

Such an air-conditioning system for vehicles comprises an air-conditioning case (1), in which an inside-air to outside-air transfer door (7) for receiving inside-air and outside-air is disposed in the inlet and vents, the openings of which are controlled by doors (9, 10, 11), are disposed in the outlet; an air blower (5) disposed in the inlet of the air-conditioning case (1); an evaporator (3) and a heater core (6) disposed in the inner path of the air-conditioning case (1); a temperature control door (8) for controlling the opening of the cool aisle and the hot aisle of the air-conditioning case (1); and a cool air accumulator (2), which is disposed to be parallel to the evaporator (3) and accumulates the cool air passed through the evaporator (3).

In the air-conditioning system for vehicles as constituted above, a compressor (not shown in the drawings), which is linked to the engine, operates, and thus a refrigerant cycle comprising the evaporator (3) operates and the inside-air and the outside-air flowed by the inside-air to the outside-air transfer door (7) are heat-exchanged in the evaporator (3) to be discharged to each vent. During this process, the cool air, which is heat-exchanged with the evaporator (3), is accumulated in the cool air accumulator (2).

In a hybrid vehicle, the engine stops during a certain period of time in case the vehicle stops due to the traffic light or traffic congestion. If a refrigerant cycle in such a hybrid vehicle cannot operate due to the engine stop, the cool air accumulated in the cool air accumulator (2) will be released to cool the inside of the vehicle.

However, the air-conditioning system for vehicles disclosed in Japanese Unexamined Patent Publication No. 2000-318431 should be equipped with a separate heat-exchanger, such as a cool air accumulator (2), which will bring about difficulties in securing a space for installation and increasing the cost for installation. Specifically, in order to accumulate sufficient cool air, the cool air accumulator (2) must have a large capacity. However, it would be difficult to install such a cool air accumulator (2) in the air-conditioning case with a restricted space. There is also a restriction for design because the cool air accumulator should be installed to be proximate to the evaporator.

The present invention was created to solve the aforesaid problems. The example of the present invention relates to minimizing the amount of a refrigerant used and possible discharge of the refrigerant, being easily applicable to the conventional air-conditioning and heating system, and minimizing the space for installation by supplying the cooled or heated air during a certain period of time after the engine stops and not modifying the conventional air-conditioning system for vehicles.

A temperature control system for vehicles according to the preferred example of the present invention comprises: an evaporator constituting the air-conditioning system; a heater core, in which a coolant flows and which heat-exchanges with the peripheral air, a first coolant circulation line, which is connected to the heater core and along which the coolant circulates between the heater core and the engine; a coolant storage, in which the coolant through the heater core is stored; and a second coolant circulation line, which is connected to the heater core and the coolant storage and along which the coolant circulates between the heater core and the coolant storage, wherein, when the air-conditioning system operates, the coolant cooled in the heater core by the heat-exchange between the evaporator and the heater core circulates along the second coolant circulation line and stored in the coolant storage; and when the operation of the air-conditioning system is stopped, the coolant stored in the coolant storage circulates along the second coolant circulation line and is supplied to the heater core.

The first coolant circulation line and the second coolant circulation line are combined together at the position where the heat core is located.

A first valve for permitting or preventing the circulation of the coolant is installed on the line where the first coolant circulation line and the second coolant circulation line are combined. The air-conditioning system operates in the order of the first mode and the second mode. In the first mode, the first valve is closed and is open in the second mode.

Further, a circulation pump, which allows the coolant to circulate along the second coolant circulation line, and a second valve, which permits or prevents the circulation of the coolant between the heater core and the coolant storage, are installed on the second coolant circulation line. In the first mode, the circulation pump stops and the second valve is closed. In the second mode, the circulation pump operates and the second valve is open.

On the first coolant circulation line, a third valve, which permits or prevents the flow of the coolant from the coolant storage to the engine, is installed. When the second mode and the air-conditioning system stop, the third valve is closed.

The temperature control system for vehicles according to the preferred example of the present invention further comprises a compressor operated by the engine and constituting the air-conditioning system, wherein the operation of the air-conditioning system is stopped when the operation of the compressor is stopped.

It is preferable but not limited that the second coolant circulation line is connected to the top of the coolant storage.

The system also comprises an air-conditioning system accommodating the evaporator and the heater core, which are used to control the temperature of the inner cabin.

The temperature control system for vehicles according to another example of the present invention comprises: a heater core, in which a coolant flows and which heat-exchanges with peripheral air, a first coolant circulation line, which is connected to the heater core and along which the coolant heated by the engine circulates between the heater core and the engine; a coolant storage, in which the coolant heated by the engine is stored; and a second coolant circulation line, which is connected to the heater core and the coolant storage and along which the coolant circulates between the heater core and the coolant storage, wherein some of the coolant heated by the engine are stored in the coolant storage during the operation of the engine, and the coolant stored in the coolant storage circulates along the second coolant circulation line and is supplied to the heater core during the stop of the engine.

The first coolant circulation line and the second coolant circulation line are combined together at the position where the heat core is located.

Further, a circulation pump, which allows the coolant to circulate along the second coolant circulation line and a second valve for permitting or preventing the circulation of the coolant between the heater core and the coolant storage are installed on the second coolant circulation line. The engine operates in the order of the first mode and the second mode. In the first mode, the circulation pump stops and the second valve is closed. In the second mode, the circulation pump operates and the second valve is open.

### Advantageous Effects of Invention

According to an example of the present invention as stated above, the coolant storage is connected to the heater core through the second coolant circulation line, and the coolant cooled by the heat-exchange between the evaporator and the heater core is stored in the coolant storage. Since the heated air can be supplied during a certain period of time even after the engine stops, the cooling and heating effect can be improved. Additionally, the required amount of a refrigerant does not increase and the possible discharge of the refrigerant is minimized by applying no modification to the conventional air-conditioning system for vehicles, such as pipe connection.

As the present invention can be configured by connecting a coolant storage, a circulation pump, and a second valve to the first coolant circulation line constituting the conventional heating system, which is used for cooling an engine, it can be easily applied to the conventional air-conditioning and heating system. Further, the present invention does not separately require a heat-exchanger, which results in minimizing the cost and space for installation.

In the temperature control system for vehicles according to the present invention, all cold energy by the operation of the air-conditioning system in the first mode, which is an initial process of operating the air-conditioning system, is used for cooling, and the cold energy by the operation of the air-conditioning system in the second mode, which operates after the first mode, is used for cooling the coolant, thereby rapidly cooling the cabin and storing the cooled coolant in the coolant storage.

Further, the temperature control system according to another example of the present invention stores the coolant heated in the coolant storage when the engine operates and the cabin is heated by using the heated coolant stored in the coolant storage when the operation of the engine is stopped.

### BRIEF DESCRIPTION OF DRAWINGS

In the following text, the invention will be described in detail with reference to the attached drawings. These drawings are used for illustration only and do not in any way limit the scope of the invention.

FIG. 1 roughly illustrates the example of the conventional air-conditioning system.

FIG. 2 illustrates some constitutions of the temperature control system for vehicles according to the present invention.

FIG. 3 is a concept drawing of the temperature control system for vehicles according to Example 1 of the present invention.

FIG. 4 is a concept drawing of some constitutions of the temperature control system for vehicles according to Example 2 of the present invention.

FIG. 5 is a flowchart showing the cooling operation of the temperature control system for vehicles according to the present invention.

FIG. 6 is a concept drawing of the temperature control system for vehicles according to Example 3 of the present invention.

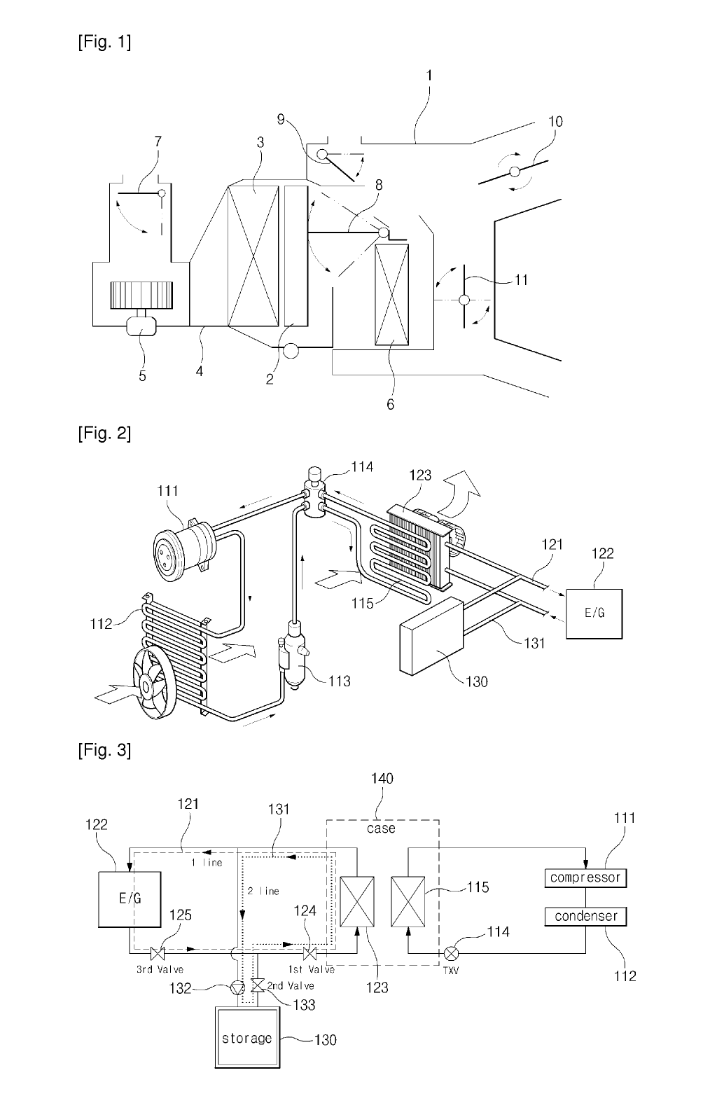

### TERMS FOR DRAWING REFERENCE NUMERALS

100, 200, 300: temperature control system for vehicles
110: air-conditioning system
111: compressor 112: condenser
113: Receiver-Dryer
114: thermostatic expansion valve
120 heating system
121: first coolant circulation line 122: engine
123: heater core 124: first valve
125: third valve
130: coolant storage
131: second coolant circulation line 132: circulation pump
133: second valve 140: air-conditioning case

### DETAILED DESCRIPTION

FIG. 2 illustrates some constitutions of the temperature control system for vehicles according to the present invention. FIG. 3 is a concept drawing of the temperature control system for vehicles according to an example of the present invention.

The temperature control system according to the present invention is used for vehicles operated by an internal combustion engine, namely, not only for general cars, but also for construction vehicles, such as a truck, a wheel loader, an excavator, etc.

The temperature control system according to the present invention is used basically to control the temperature of the inside of the vehicle, such as a cabin of construction vehicles, but is not limited to them, i.e., it can be used to cool other system or components of the vehicle, like the cooling an electric battery. For the convenience of explanation, below is an example of controlling the temperature of the inside of a cabin.

The temperature control system according to the present invention uses an air-conditioning system (110) and a heating system to supplement insufficient cooling or heat source after the engine (122) stops, and is configured to use a normal air-conditioning system (110) and heating system (120) used in the conventional vehicles.

That is, the temperature control system according to the present invention does not form a new structure and type of air-conditioning system (110) or heating system (120), but it is configured to be applicable to the general type of air-conditioning system (110) and heating system (120) for vehicles.

In order to help the understanding of the present invention, below is an explanation regarding an air-conditioning system (110) and heating system (120).

In the present invention, an air-conditioning system (110) comprises a compressor (111), a condenser (112), a receiver-dryer (113), a thermostatic expansion valve (TXV, 114), and an evaporator (115), and a refrigerant circulates through a pipe (116) by which each component is connected.

A refrigerant gas, which is compressed at high temperature and with high pressure in a compressor (111) that is linked to an engine (122) of the vehicle, circulates as follows: the refrigerant gas is forcibly cooled and condensed in the condenser (112); water and foreign substances contained in the refrigerant are removed through the receiver-dryer (113); then the purified liquid refrigerant is delivered to the thermostatic expansion valve (114) and enters the evaporator (115) in the state of low temperature and low pressure; the refrigerant in the evaporator (115) takes the heat from the peripheral air, i.e., cools down the peripheral air, and then One cycle is completed as the refrigerant returns to the compressor.

The cooled air around the evaporator (115) is supplied to the inside of the vehicle, and thus the vehicle is cooled.

Below is a brief explanation regarding a heating system (120) of the present invention.

A heating system (120) comprises a water jacket (not shown in the drawings), which allows the engine (122) to be normally operated by lowering the high temperature in combustion, which results from being in contact with a combustion chamber (not shown in the drawings) as a coolant path formed in a cylinder block (not shown in the drawings) of the engine (122) and a cylinder header (not shown in the drawings), to an appropriate temperature; a heater core (123) used for heating; and a water pump (not shown in the drawings), which delivers and circulates the coolant to the water jacket and the heater core (123) and is forcibly operated, wherein the coolant circulates through a pipe (a first coolant circulation line (121)), by which each component is connected.

The heater core (123) can be heat-exchanged with peripheral air, and is installed in close proximity with the evaporator (115). It is desirable to install the heater core (123) and the evaporator (115) in the air-conditioning case in order to increase mutual heat-exchange efficiency and smoothly supply the cooled or heated outer air into the cabin.

As stated above, on the one hand the engine (122) is cooled by moving the high-temperature heat produced in the engine (122) to the outside of the engine (122) to be cooled, and on the other hand the high heat heated by the engine (122) is supplied to the inside of the vehicle to heat the vehicle.

### Example 1

The temperature control system according to Example 1 is a system to supplement insufficient heat source for cooling after the engine (122) stops, and uses an air-conditioning system (110) and a heating system.

The temperature control system (100) according to Example 1 of the present invention comprises a coolant storage (130) and a second coolant circulation line (131) in addition to the evaporator (115) constituting the aforesaid air-conditioning system (110), the heater core (123) constituting the aforesaid hating system (120), and the first coolant circulation line (121).

The coolant storage (130) is connected to the heater core (123) through the second coolant circulation line (131), and stores the coolant through the heater core (123). It is desirable to insulate the outer wall of the coolant storage (130) in order to maintain the temperature of the coolant stored therein.

Although the second coolant circulation line (131) forms a route through which the coolant circulates, it is distinguishable from the first coolant circulation line (121) and is configured to let the coolant circulate between the heater core (123) and the coolant storage (130). The second coolant circulation line (131) can be configured to be combined with the first coolant circulation line (121) at the position where the heater core (123) is formed, as shown in FIG. 3. That is, the second coolant circulation line (131) is partially integrated with the first coolant circulation line (121), which is distinguishable from Example 2.

The second coolant circulation line (131) may be connected to the top of the coolant storage (130). The cold coolant flowed in the coolant storage (13) through the second circulation lien (131) moves downwards to the coolant storage (13) and the coolant not cooled moves upwards by convection. Thus, the coolant required to be cooled can be smoothly circulated through the second coolant circulation line (131).

The temperature control system for vehicles (100) according to the present invention comprises a first valve (124), a circulation pump (132), a second valve (133), and a third valve (125), in addition to the aforesaid components.

The first valve (124) is installed on the line where the first coolant circulation line (121) and the second coolant circulation line (131) are combined, and prevent the coolant from being discharged from the heater core (123) or from flowing into the heater core (123). That is, if the first valve (124) is closed, the flow of the coolant in the heater core (123) is stopped. In such a case, the entire flow of the coolant may be stopped on the first coolant circulation line (121), whereas the coolant flowed from the engine (122) to the first valve (12) is bypassed prior to the first valve (124), and thus can be configured to flow towards the engine (122).

The circulation pump (132) is installed on the second coolant circulation line (131), and forces the coolant to be circulated along the second coolant circulation line (131).

The second valve (133) is also installed on the second coolant circulation line (131), and controls flowing the coolant into the coolant storage (130) or discharging the coolant to the coolant storage (130).

The third valve (125) is formed on the first coolant circulation line (121) and controls the coolant to flow towards the engine (122). The third valve (125) is a means for preventing the coolant from flowing from the coolant storage (130) towards the engine (122), rather than a means for preventing the coolant from flowing from the heater core (123) towards the engine (122).

According to the preferred example of the present invention, the first valve (124), the second valve (133), and the third valve (125) are solenoid on-off valves controlled by electricity, and the circulation pump (132) is an electric pump.

### Example 2

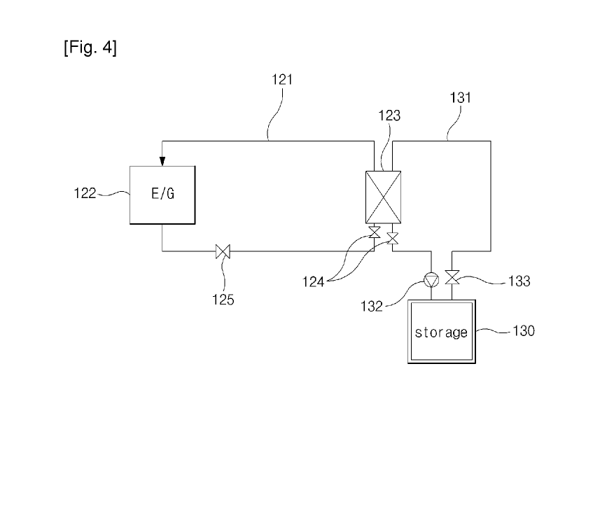

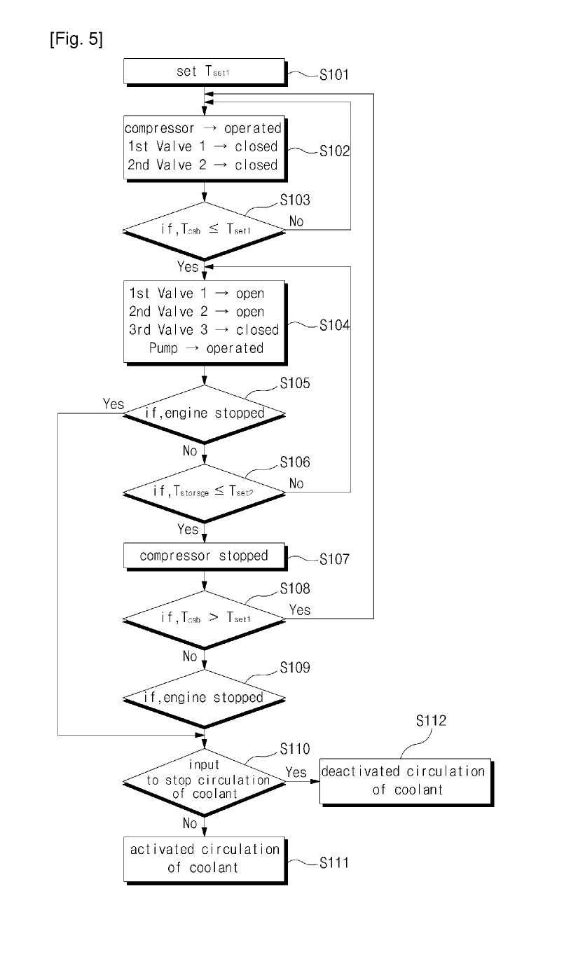

FIG. 4 is a concept drawing illustrating some constitutions of the temperature control system for vehicles according to Example 2 of the present invention.

An air-conditioning system (110) is not merely omitted in FIG. 4. The air-conditioning system (110) comprising the evaporator (115), which is heat-exchanged with the heater core (123), is naturally included in Example 2.

The temperature control system (200) according to Example 2 of the present invention is the same as the temperature control system (100) according to the aforesaid Example 1, except for the second coolant circulation line (131).

While the second coolant circulation line (131) according to Example 1 (100) is formed to be combined with the first coolant circulation line (121) on the portion where the heater core (123) is formed, the first coolant circulation line (121) and the second coolant circulation lien (131) are not combined in the temperature control system (200) according to Example 2. Accordingly, the coolant individually moves along the first circulation line (121) and the second coolant circulation line (131), and can be intersected in the heater core (123).

Operation of the Temperature Control System according to Examples 1 and 2

Below is an explanation regarding the process of cooling the inside of the cabin using the temperature control system for vehicles according to the present invention with reference to FIG. 5.

In order to operate the temperature control system for vehicles (100, 200) according to the present invention, the operator sets a first set temperature (Test1) (S101).

Once the first set temperature is set by the operator, the compressor (111) operates by the engine (122) and the air-conditioning system (110) operates. Accordingly, the refrigerant passed through the compressor (111), the condenser (112), the Receiver-Dryer (113) and the thermostatic expansion valve (114) absorbs the peripheral heat to lower the temperature of the inside of the air-conditioning case (140) while passing through the evaporator (115). The air lowered in the air-conditioning case (140) is discharged to the vent and cools the inside of the cabin. In such a case, the first valve (124) and the second valve (133) are closed, and the operation of the circulation pump (132) is stopped (S102).

As stated above, when the air-conditioning system (110) in the present invention is initially operated, the coolant in the heater core (123) flows towards neither the engine (122) along the first coolant circulation line (121) nor the coolant storage (130) along the second coolant circulation line (131). This step corresponds to a first mode.

That is, in the first mode of the operation of the air-conditioning system (110), the cooling energy by the operation of the air-conditioning system (110) is not used for cooling the coolant that exists along the second coolant circulation line (131). Most of such cooling energy is used for lowering the temperature (Tcab) of the inside of the cabin to rapidly cool the inside of the cabin.

If the temperature (Tcab) of the insider of the cabin reaches the first set temperature (S103), the first valve (124) and the second valve (133) are open and the circulation pump (132) operates.

Accordingly, the coolant circulates through the second coolant circulation line (133). Since there is the heat-exchange between the evaporator (115) and the heater core (123), the coolant flowing inside the heater core (123) is gradually cooled, and the coolant in the coolant storage (130) is also gradually cooled. In such a case, the third valve (125) is closed in order to prevent the coolant from being re-heated after the coolant moves to the engine (122) (S104).

As stated above, when the air-conditioning system operates after the temperature of the inside of the cabin reaches the first set temperature (Tset1), the coolant cooled in the inside of the heater core (123) by the heat-exchange with the evaporator (115) will flow towards the coolant storage (130) along the second coolant circulation line (131), not towards the engine (122) along the first coolant circulation line (121). This step corresponds to a second mode.

That is, in the second mode of the operation of the air-conditioning system (110), since the temperature of the inside of the cabin is sufficiently lowered, the cooling energy by the operation of the air-conditioning system (110) is also used for cooling the coolant that exists along the second coolant circulation line (131), and can gradually cool the temperature of the coolant in the coolant storage (130).

In the process of cooling the coolant that exists on the second coolant circulation line (131), the engine (122) may stop, such as the case the engine automatically stops when the hybrid vehicle or idle-stop vehicle stops to wait for the traffic light or other reasons causing short stops of the vehicle. (S105).

If the engine (122) stops, the operation of the compressor (111), which is linked to the engine (122), will be stopped, and thus the inside of the cabin cannot be cooled by the air-conditioning system (110). However, the cooled coolant that exists inside the coolant storage (130) moves along the second coolant circulation line (131) and passes through the heater cores (123) to cool the inside of the cabin by the heat-exchange through the heater core (123). A further explanation thereof will be provided below (S112).

If the compressor (111) continuously operates while the engine does not stop, there will be a continuous heat-exchange between the evaporator (115) and the heater core (123) and the coolant on the second coolant circulation line (131) will be sufficiently lowered. Such a sufficiently lowered temperature becomes a second set temperature (Tset2). The second set temperature (Tset2) sets the temperature (Tstorage) of the inside of the coolant storage (130), and depends on the first set temperature (Tset1). For example, if the first set temperature (Tset1) is set as 23° C., the second set temperature (Tset2) may be set as 10° C. (S106).

When the temperature (Tstorage) of the inside of the coolant storage (130) reaches the second set temperature (Tset2), since the temperature (Tcab) of the inside of the cabin is below the first set temperature (Tset1) and the coolant in the inside of the second coolant circulation line (131) is sufficiently cooled down, the operation of the air-conditioning system (110) is not necessary anymore and stopped along with the compressor (111) (S107).

If the temperature (Tcab) of the inside of the cabin increases to be in excess of the first set temperature (Tset1) after the operation of the air-conditioning system (110) is stopped, the air-conditioning system (110) will re-operate for cooling (S108).

When the engine (122) of the vehicle stops, the inside of the cabin can be cooled by the cooled coolant that exists inside the coolant storage (130), although it is not cooled by the air-conditioning system (110) (S109). That is, the coolant in the coolant storage (130) passes through the heater core (123) along the second coolant circulation line (131) and cools the air around the heater core (123) by the heat-exchange through the heater core (123), and then the cooled air flows into the cabin for cooling (S11).

The cooling through the second coolant circulation line (131) is not always performed, but is determined by operator's choice (S110).

That is, if the operator wants no longer cooling, the cooling through the second coolant circulation line (131) will be prevented, and the cooling energy of the coolant that exists inside the second coolant circulation line (131) will not be delivered to the inside of the cabin. Such operation can be performed by the input of information, which allows the first valve (124) or the second valve (133) to be closed and the input of information, which allows the vent of the air-conditioning case (140) to be closed (S112).

### Example 3

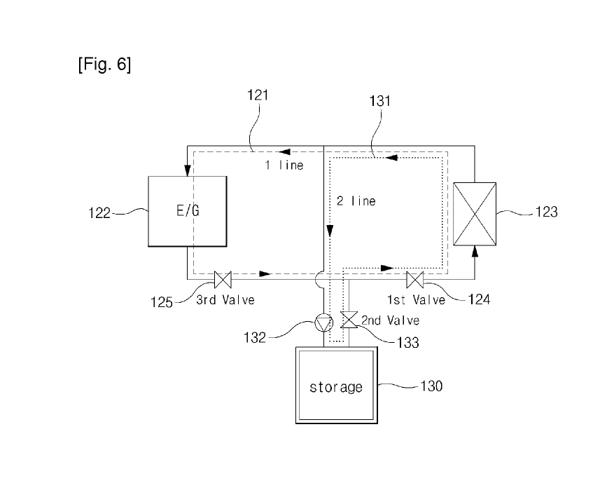

FIG. 6 is a concept drawing of the temperature control system for vehicles (300) according to Example 3 of the present invention.

The temperature control system for vehicles (300) according to Example 3 is a system for supplementing an insufficient heat source for heating after the engine (122) stops, uses the heating system, and is configured as in Example 1, from which the air-conditioning system should be excluded.

Accordingly, the temperature control system for vehicles (300) according to Example 3 comprises a heating system (120), which comprises the heater core (123) and the first coolant circulation line, the coolant storage (130), the second coolant circulation line, the first valve (124) (which is always open in order to supply a heat source for heating the inside of the cabin), the second valve (133), the third valve (125), and the circulation pump (132).

The temperature control system (300) according to Example 3 is characterized in that the coolant heated by the engine (122) is stored in the coolant storage (130).

That is, the coolant heated by the engine (122) is stored in the coolant storage during the operation of the engine (122), and the inside of the cabin is heated by the heated coolant stored in the coolant storage (130) during the stop of the engine (122).

Operation of the Temperature Control System according to Example 3

In order to rapidly heat the inside of the cabin, the temperature control system (300) according to Example 3 operates in two different modes, the first mode and the second mode, as explained below.

If the operator sets the temperature for heating or an automatic climate control system asks for heating, the coolant heated by the engine (122) will flow through the first coolant circulation line (121) and pass through the heater core (123) to supply heat to the peripheral air and increase the temperature of the inside of the air-conditioning case (140). The air increased in the air-conditioning case (140) is discharged to the vent and heats the inside of the cabin. In such a case, the first valve (124) and the third valve (125) are open, the second valve (133) is closed, and the operation of the circulation pump (132) is stopped.

As stated above, when the heating system in the present invention initially operates, the coolant in the heater core (123) does not flow towards the coolant storage (130) along the second coolant circulation line (131). This step corresponds to a first mode.

That is, in the first mode of the operation of the heating system (120), the heating energy by the operation of the heating system (120) is not used to heat the coolant that exists along the second coolant circulation line (131). Most of such energy is used to increase the temperature of the inside of the cabin to rapidly heat the inside the cabin.

If the temperature of the inside of the cabin reaches the temperature set by the operator, the second valve (133) is open and the circulation pump (132) operates. Accordingly, the coolant circulates through the second coolant circulation line (131). The coolant flowing inside the second coolant circulation line (131) is gradually heated and the coolant in the coolant storage (130) is also gradually heated.

As stated above, if the heating system (120) operates after the temperature of the inside of the cabin reaches the set temperature, the heated coolant flows towards the coolant storage (130) along the second coolant circulation line (131). This step corresponds to a second mode.

If the engine (122) of the vehicle stops, the coolant heated by the engine (122) will not be continuously supplied to the heater core (123), and thus the inside of the cabin will not be heated by the heating system (120). However, the heated coolant that exists inside the coolant storage (130) moves along the second coolant circulation line (131) and passes through the heater core (123) to heat the inside of the cabin by the heat-exchange through the heater core (123).

### INDUSTRIAL APPLICABILITY

The temperature control system for vehicles according to the present invention allows the cooled or heated air to be supplied during a certain period of time after the engine stops and does not modify the conventional air-conditioning system for vehicles, which does not result in increasing the required amount of refrigerant and minimizing the possibility of discharging the refrigerant. Accordingly, the present invention is very suitable for vehicles, which consider improvement of fuel efficiency and prevention of environmental pollution.

Further, the present invention is configured only by connecting the coolant storage, the circulation pump and the second valve to the conventional heating system, and thus can be easily applied to the conventional air-conditioning and heating system. Since a separate heat-exchanger is not additionally required, the cost and space for installation can be minimized.

1. A temperature control system for vehicles comprising:
an evaporator constituting an air-conditioning system;
a heater core, which is installed to be proximate to the evaporator and heat-exchanges with the peripheral air while a coolant flows inside;
a first coolant circulation line, which is connected to the heater core, and allows the coolant heated by the engine to circulate between the heater core and the engine;
a coolant storage, in which the coolant through the heater core is stored; and
a second coolant circulation line, by which the heater core and the coolant storage are connected, and which allows the coolant to circulate between the heater core and the coolant storage, wherein the coolant cooled in the heater core by the heat-exchange between the evaporator and the heater core circulates along the second coolant circulation line to be stored in the coolant storage during the operation of the air-conditioning system, and the coolant stored in the coolant storage circulates along the second coolant circulation line to be supplied to the heater core during the stop of the air-conditioning system.

2. The temperature control system for vehicles according to claim 1, wherein the first coolant circulation line and the second coolant circulation line are combined at the portion where the heater core is located.

3. The temperature control system for vehicles according to claim 2, wherein a first valve, which permits or prevents the circulation of the coolant, is installed at the position where the first coolant circulation line and the second coolant circulation line are combined; the air-conditioning system operates in the order of the first mode and the second mode; and the first valve is closed in the first mode and open in the second mode.

4. The temperature control system for vehicles according to claim 3, wherein a circulation pump, which allows the coolant to circulate along the second coolant circulation line, and a second valve, which permits or prevents the circulation of the coolant between the heater core and the coolant storage, are installed on the second coolant circulation line; the circulation pump stops and the second valve is closed in the first mode; and the circulation pump operates and the second valve is open in the second mode.

5. The temperature control system for vehicles according to claim 4, wherein a third valve, which permits or prevents the flow of the coolant from the coolant storage towards the engine, is installed on the first coolant circulation line; and the third valve is closed in the second mode when the operation of the air-conditioning system is stopped.

6. The temperature control system for vehicles according to claim 1, further comprising a compressor operated by the engine and constituting the air-conditioning system, wherein the operation of the air-conditioning system is stopped while the operation of the compressor is stopped.

7. The temperature control system according to claim 1, wherein the second coolant circulation line is connected to the top of the coolant storage.

8. The temperature control system according to claim 1, which comprises an air-conditioning case accommodating the evaporator and the heater core

9. The temperature control system according to claim 1, wherein the evaporator and the heater core are used to control the temperature of the inside of the cabin.

10. The temperature control system comprising:
a heater core, which heat-exchanges with the peripheral air while a coolant flows inside;
a first coolant circulation line, which is connected to the heater core, and allows the coolant to circulate between the heater core and the engine;
a coolant storage, which stores the coolant heated by the engine; and
a second coolant circulation line, by which the heater core and the coolant storage are connected, and which allows the coolant to circulate between the heater core and the coolant storage;
wherein some of the coolant heated by the engine are stored in the coolant storage during the operation of the engine, and the coolant stored in the coolant storage circulates along the second coolant circulation line to be supplied to the heater core during the stop of the engine.

11. The temperature control system according to claim 10, wherein the first coolant circulation line and the second coolant circulation line are combined at the position where the heater core is located.

12. The temperature control system according to claim 11, wherein a circulation pump, which allows the coolant to circulate along the second coolant circulation line, and a second valve, which permits or prevents the circulation of the coolant between the heater core and the coolant storage, are installed on the second coolant circulation line; the engine operates in the order of the first mode and the second mode; and the circulation pump stops and the second valve is closed in the first mode, and the circulation pump operates and the second valve is open in the second mode.
